(19) United States
(12) Patent Application Publication
(10) Pub. No.: US 2025/0162798 A1
(43) Pub. Date: May 22, 2025

(54) METHOD FOR RECOGNIZING LOCATION OF OVERHEAD HOIST TRANSPORT FOR OVERHEAD HOIST TRANSPORT SYSTEM

(71) Applicant: CANTOPS CO., LTD., Gyeonggi-do (KR)

(72) Inventors: Hak Seo OH, Gyeonggi-do (KR); Youl Kwon SUNG, Gyeonggi-do (KR); Sung Ik KIM, Gyeonggi-do (KR); Deok Ha LEE, Gyeonggi-do (KR); Yun Jung PARK, Gyeonggi-do (KR); Seong Min HWANG, Gyeonggi-do (KR); Won Jai LEE, Gyeonggi-do (KR); Sung Hyuk YOUN, Incheon (KR); Se Hun LEE, Gyeonggi-do (KR); Jung Kil PARK, Gyeonggi-do (KR); Mo Hyun KIM, Seoul (KR); Hyun Woo JO, Gyeonggi-do (KR); Young Sun HONG, Gyeonggi-do (KR); Tae Min KANG, Gyeonggi-do (KR)

(21) Appl. No.: 18/676,861

(22) Filed: May 29, 2024

(30) Foreign Application Priority Data
Nov. 21, 2023 (KR) 10-2023-0161844

(51) Int. Cl. B65G 1/04

(52) U.S. Cl. CPC B65G 1/0464; B65G 2203/0283

(57) ABSTRACT

A method for recognizing a location of an overhead hoist transport for an overhead hoist transport system, by which a process designing time can be shortened and thus costs can be reduced by installing location indicators in the same way at each semiconductor factory at the time of process design by acquiring accurate location information of the overhead hoist transport in real time and determining a work location based on the location information, there is no need to reattach location indicators and thus there is no need to work at heights due to reattachment work of the location indicators even in a case of changing work environment such as changing layout of a process or changing position of equipment so that a work time and costs thereof can be significantly reduced, and it is possible to remarkably improve post management and significantly improve efficiency of logistics transportation.

### BACKGROUND

The present invention relates to a method for recognizing a location of an overhead hoist transport for an overhead hoist transport system, and more specifically, to a method for recognizing a location of an overhead hoist transport for an overhead hoist transport system, by which there is no need to work at heights so that working time and costs can be reduced, and a fault-diagnosis location can be precisely identified while a current location of the overhead hoist transport can be accurately and rapidly recognized during line operation.

Generally, in semiconductor or OLED production lines, an OHT (Overhead Hoist Transport) is widely used as a hoist transport to transport various objects such as wafers and so on.

These OHTs move to the destination along a rail installed on a ceiling of the production line according to a transfer order thereof, and the objects are transferred through a handoff process (the task of moving logistics from one of the OHT and the production equipment to the other) with each production equipment.

Usually, each production line is equipped with a large number of production equipment, and in order to cope with this, a large number of OHTs (hereinafter referred to as ‘overhead hoist transport’) move along the rail and repeatedly perform the handoff process. In general, to ensure the stable handoff operation, it is performed after the overhead hoist transport stops at the work location on the rail.

At this time, in order to achieve a smooth and accurate handoff operation between the overhead hoist transport and the target equipment, it is important for the overhead hoist transport to stop accurately at the work location thereof. To this end, conventionally, the overhead hoist transport is stopped at the work location thereof by attaching location indicators such as QR codes, barcodes, tags, etc. to the work locations on the rail and installing a display reader on the overhead hoist transport to recognize the location indicators.

Here, although it varies depending on the size of the factory or the number of equipment, in general, since the production line requires thousands to tens of thousands of location indicators to be attached at designated locations thereof, it takes a lot of time to design the attachment location of the location indicator during process design thereof. In addition, when a change in the location of the location indicator is required due to a change in the layout of the process or a change in the location of equipment, it takes a considerable amount of time to remove the existing location indicator and reattach it. Therefore, there is a problem that adversely affected the production efficiency of the production line.

In addition, the height of the ceiling, where the rail is installed, is usually more than 3 m, so the reinstallation work of the above-mentioned location indicators is also performed at a high location, which has the problem of adding a lot of cost to ensure the safety of workers.

Meanwhile, at semiconductor line sites that emphasize work efficiency, attempts to diagnose failures and prevent accidents in advance has been increased. As part of this, various devices (vibration sensors, noise sensors, cameras, etc.) are attached to the overhead hoist transport and data for failure analysis is collected as it moves. At this time, since the location information between the location indicators during the line operation, that is, the current location information of the overhead hoist transport in the area between neighboring nodes cannot be precisely recognized, it is difficult to precisely identify the fault location, even if the fault diagnosis is performed using the collected data.

Accordingly, a method of determining the current location of the overhead hoist transport using an acceleration sensor has been proposed. However, since the acceleration sensor has a lot of noise, the location error increases, making it difficult to apply to OHT systems such as semiconductor production lines, etc. that require precision of several millimeters or less.

### PATENT LITERATURE

Patent Literature 1: Korean Patent Publication No. 10-2021-0091548 (Moving object control system for controlling moving object using 3D camera system; Jul. 22, 2021)
Patent Literature 2: Korean Patent Publication No. 10-2022-0094915 (Task guidance apparatus for use in in-door cargo transport; Jul. 6, 2022)

### SUMMARY OF THE INVENTION

The invention is made to solve the problem described above, and an object of the invention is to provide a method for recognizing a location of an overhead hoist transport for an overhead hoist transport system, by which a process designing time can be shortened and thus costs can be reduced by installing location indicators in the same way at each semiconductor factory at the time of process design by acquiring accurate location information of the overhead hoist transport in real time and determining a work location based on the location information, there is no need to reattach location indicators and thus there is no need to work at heights due to reattachment work of the location indicators even in a case of changing work environment such as changing layout of a process or changing position of equipment so that a work time and costs thereof can be significantly reduced, and it is possible to remarkably improve post management and significantly improve efficiency of logistics transportation.

Another object of the invention is to provide a method for recognizing a location of an overhead hoist transport for an overhead hoist transport system by which a location of an abnormal sign can be transmitted with an abnormal sign signal to a preset terminal when an abnormality such as damage, breakage, or deformation of a rail occurs during traveling of the overhead hoist transport so that an abnormal state of the rail can be detected in real time.

According to an aspect of the invention to achieve the object described above, there is provided a method for recognizing a location of an overhead hoist transport for an overhead hoist transport system that includes a rail installed on a ceiling of a work site along a preset route in advance, multiple location indicators attached at one side of the rail at preset intervals, an overhead hoist transport installed to be travelable along the rail, and an imaging unit which is installed at one side of the overhead hoist transport and acquires an image by imaging, of the rail, the one side of the rail corresponding to the overhead hoist transport and each of the location indicators, the method including: an image acquiring step of acquiring a first image acquired by imaging, by the imaging unit, the one side of the rail immediately before the overhead hoist transport starts traveling and a second image acquired by imaging the one side of the rail at a current location of the traveling overhead hoist transport; a reference location information acquiring step of acquiring, in a case where any one of the location indicators is detected on the first image, location information corresponding to the detected location indicator from location data stored in advance; a feature point setting step of setting, as a feature point, a random pattern on the first image; and a location information calculating step of calculating current location information of the overhead hoist transport based on the location information acquired in the reference location information acquiring step and a movement amount depending on a movement displacement of a feature point which is detected by comparing the first image with the second image.

In addition, the location information calculating step includes a movement displacement detecting step of detecting the movement displacement of the feature point by comparing the first image with the second image, a pixel count measuring step of measuring pixel counts on an X axis and a Y axis from a location of the feature point on the first image to a location of the feature point on the second image depending on the detected movement displacement of the feature point, a movement amount calculating step of calculating a movement amount of the overhead hoist transport based on the measured pixel counts on the X axis and the Y axis, and a location information acquiring step of acquiring current location information of the overhead hoist transport by adding the calculated movement amount of the overhead hoist transport to the location information acquired in the reference location information acquiring step.

In addition, the location information calculating step further includes an interval calculating step of calculating a distance between the location indicator and the location indicator by using the current location information of the overhead hoist transport, and a correction value calculating step of calculating a correction value for the movement amount of the overhead hoist transport based on a difference value obtained by comparing the distance between the location indicator and the location indicator calculated in the interval calculating step with an actual distance between the location indicator and the location indicator stored in advance, and in a case where the movement amount calculating step is executed after the correction value is calculated, the correction value is reflected to the calculated movement amount of the overhead hoist transport.

Meanwhile, according to another aspect of the invention to achieve the object described above, there is provided a method for recognizing a location of an overhead hoist transport for an overhead hoist transport system that includes a rail which is installed on a ceiling of a work site along a preset route in advance and has a first horizontal line and a second horizontal line parallel to each other at an upper side and a lower side in a length direction and a location recognition line diagonally connecting the first horizontal line and the second horizontal line, multiple location indicators attached at one side of the rail at preset intervals, an overhead hoist transport installed to be travelable along the rail, and an imaging unit which is installed at one side of the overhead hoist transport and acquires an image by detecting each of the location indicators and performing line scanning on, of the rail, the one side of the rail corresponding to the overhead hoist transport, the method including: an image acquiring step of acquiring an image acquired by performing the line scanning on the one side of the rail at a current location of the overhead hoist transport; a reference location information acquiring step of acquiring, in a case where any one of the location indicators is detected by the imaging unit, location information corresponding to the detected location indicator from location data stored in advance; and a location information calculating step of acquiring current location information of the overhead hoist transport based on a movement amount of the overhead hoist transport calculated by analyzing the image and the location information of the detected location indicator acquired in the reference location information acquiring step, wherein the location information calculating step includes an intersection point detecting step of detecting intersection points (P1, P2, and P3) at which a vertical scan line of the imaging unit intersects the first and second horizontal lines and the location recognition line, respectively, on the image, a movement amount calculating step of calculating an actual movement amount (M″) of the overhead hoist transport by setting, as (h), either a height between the intersection point (P2) and the intersection point (P3) or a height between the intersection point (P3) and the intersection point (P1) and substituting (h) into the following [Equation], and a location information acquiring step of acquiring current location information of the overhead hoist transport by adding the calculated actual movement amount of the overhead hoist transport to the location information of the detected location indicator acquired in the reference location information acquiring step.

$${M}^{″} = D \times h / H \qquad [ Equation ]$$

(where, D represents a distance on an X axis between a first point at which the location recognition line intersects the first horizontal line and a second point at which the location recognition line intersects the second horizontal line, and H represents an interval between the first and second horizontal lines.)

In addition, the method for recognizing a location of an overhead hoist transport for an overhead hoist transport system further includes an abnormal sign sensing step of determining, as an abnormality, a case where the movement displacement of the feature point detected in the movement displacement detecting step is out of a preset reference range and transmitting the current location information of the overhead hoist transport with an abnormal sign signal to a preset target terminal.

In addition, the method for recognizing a location of an overhead hoist transport for an overhead hoist transport system further includes an initializing step of initializing the movement amount of the overhead hoist transport in a case where any one of the location indicators is detected in the reference location information acquiring step.

### BRIEF DESCRIPTION OF THE DRAWINGS

The above and other objects, features and advantages of the present invention will be more apparent from the following detailed description taken in confluence with the accompanying drawings, in which:

FIG. 1 is a view schematically illustrating an overhead hoist transport system according to an embodiment of the invention;

FIG. 2 is a flowchart sequentially illustrating the method for recognizing a location of an overhead hoist transport for an overhead hoist transport system according to the embodiment of the invention;

FIG. 3 is a view schematically illustrating a principle for detecting movement direction according to the embodiment of the invention;

FIG. 4 is a view schematically illustrating a principle for measuring pixel count according to the embodiment of the invention;

FIG. 5 is a flowchart sequentially illustrating a method for recognizing a location of an overhead hoist transport in an overhead hoist transport system according to another embodiment of the invention;

FIG. 6 is a view illustrating the one side of the rail at which first and second horizontal lines and a location recognition line are provided according to the other embodiment of the invention; and

FIG. 7 is a view illustrating intersection points (P1, P2, and P3) according to the embodiment of the invention.

### REFERENCE SIGNS LIST

10: rail
20: overhead hoist transport
30: imaging unit
40: analyzer
L1: first horizontal line
L2: second horizontal line
L3: location recognition line

### DETAILED DESCRIPTION OF THE PREFERRED EMBODIMENT

Hereinafter, a preferred embodiment of the invention will be described in detail with reference to the accompanying drawings.

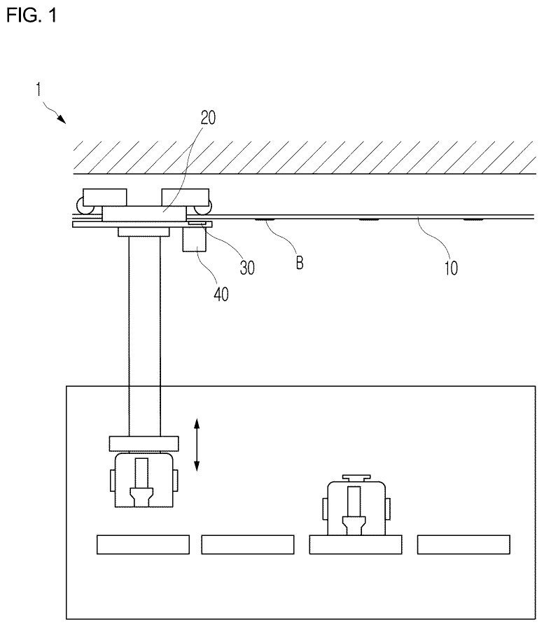

FIG. 1 is a view schematically illustrating an overhead hoist transport system according to an embodiment of the invention.

Before a method for recognizing a location of an overhead hoist transport for the overhead hoist transport system according to the embodiment of the invention, a basic structure of an overhead hoist transport system (1) according to this embodiment is described. The embodiment relates to a logistics overhead hoist transport apparatus that performs logistics transportation through a handoff to a specific device at a work site and may include a rail (10) installed on a ceiling of the work site along a preset route, location indicators (B) attached at preset intervals along the rail (10), an overhead hoist transport (20) that travels along the rail (10), an imaging unit (30) installed at one side of the overhead hoist transport (20), and an analyzer (40) that recognizes a current location of the overhead hoist transport (20) by analyzing the image.

Here, the location indicator (B) can be configured of a barcode, an RF tag, or a QR code, each attached location indicator (B) stores a unique identification number, and location information according to the identification number is stored in the overhead hoist transport or an external server in advance.

In addition, the imaging unit (30) according to this embodiment is installed on one side of the overhead hoist transport (20) and travels with the overhead hoist transport (20) and fulfills functions of imaging the one side of the rail (10) in a traveling process of the overhead hoist transport (20) and acquiring an image thereof.

Further, the imaging unit (30) can be configured of not only a code reader, an optical sensor, an image sensor, or the like, but also including two types of devices such as a code reader and an optical sensor thereof.

The analyzer (40) analyzes the image acquired by the imaging unit (30) and recognizes a current location of the overhead hoist transport (20). Hereinafter, the method for recognizing an overhead hoist transport for an overhead hoist transport system will be described.

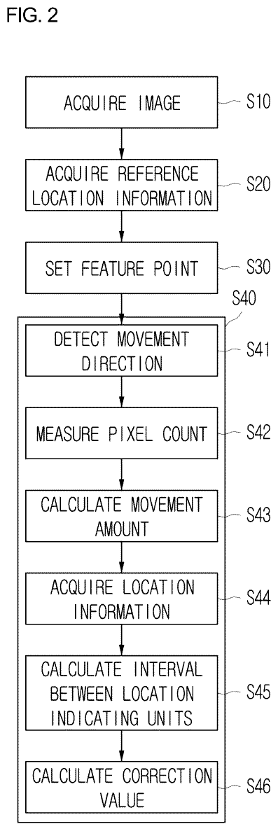

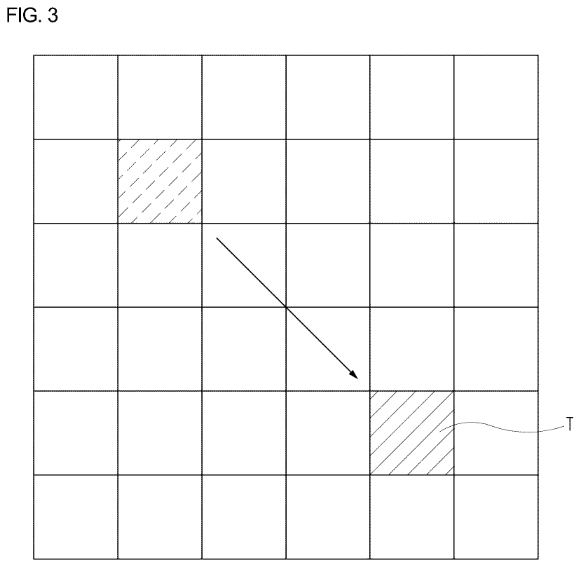

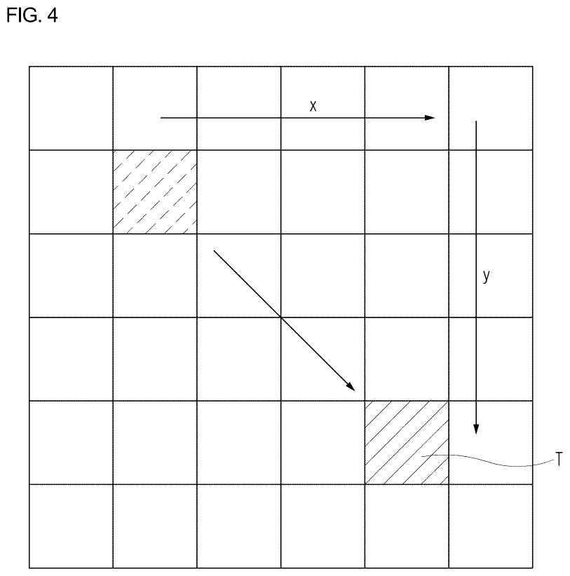

FIG. 2 is a flowchart sequentially illustrating the method for recognizing a location of an overhead hoist transport for an overhead hoist transport system according to the embodiment of the invention, FIG. 3 is a view schematically illustrating a principle for detecting movement direction according to the embodiment of the invention, and FIG. 4 is a view schematically illustrating a principle for measuring pixel count according to the embodiment of the invention.

As illustrated in FIG. 2, the method for recognizing a location of an overhead hoist transport for an overhead hoist transport system according to the embodiment of the invention includes an image acquiring step (S10), a reference location information acquiring step (S20), a feature point setting step (S30), and a movement displacement detecting step and a location information calculating step (S40).

Acquisition of Image (S10) The imaging unit (30) is installed at one side of the overhead hoist transport (20) and fulfills a function of imaging, of one side of the rail (10), the one side of the rail (10) corresponding to the overhead hoist transport (20). Hence, the imaging unit (30) images the rail (10) and acquires a first image immediately before the overhead hoist transport (20) travels along the rail (10).

Then, the imaging unit images the rail (10) again while the overhead hoist transport (20) is traveling along the rail (10) and acquires second images, and a plurality of images acquired in this way are transmitted to the analyzer (40).

### Acquisition of Reference Location Information (S20)

Before the analyzer (40) analyzes location information of the overhead hoist transport (20), the analyzer (40) determines whether a location indicator (B) on the first image is detected. This is to acquire location information that serves as a reference when trying to calculate a current real-time location of the overhead hoist transport (20). When the location indicator is detected on the first image, a unique identification number is read, location information corresponding to the read identification number is acquired from location data stored in the overhead hoist transport or a server in advance, and a reference location thereof is set.

### Setting of Feature Point (S30)

In addition, the analyzer sets a specific region or a specific location as a feature point (T) on the first image among the images transmitted from the imaging unit (30).

In this embodiment, as illustrated in FIG. 3, one pixel is illustrated as the feature point (T) for convenience of description, but the invention is not necessarily limited to this, and a specific pattern can also be set as the feature point (T).

### Calculation of Location Information (S40)

After the feature point is set, the analyzer (40) calculates the location information of the overhead hoist transport (20), and the location information calculating step (S40) according to this embodiment may include a movement displacement detecting step (S41), a pixel count measuring step (S42), a movement amount calculating step (S43), and a location information acquiring step (S44).

First, in the movement displacement detecting step (S41), as illustrated in FIG. 3, a movement direction of the feature point (T) is detected by comparing locations of the feature point on the first image and the second image.

When the movement direction of the feature point (T) is detected, in the pixel count measuring step (S42), as illustrated in FIG. 4, pixel counts Δx and Δy on an X axis and a Y axis are measured from an initial location of the feature point (T) to a current location of the moved feature point (T), that is, between a location of the feature point (T) on the first image and a location of the feature point on the second image.

Next, an actual movement amount of the overhead hoist transport (20) is calculated by substituting the measured pixel counts on the X and Y axes into preset Equation 1 below.

$${M}^{′} = \sqrt{Δ {x}^{2} + Δ {y}^{2}} \times d \qquad [ Equation 1 ]$$

(here, Δx represents the number of pixels through which the feature point has moved in an x-axis direction, Δy represents the number of pixels through which the feature point has moved in a y-axis direction, and d represents a preset actual distance per pixel.)

When the actual movement amount of the overhead hoist transport (20) is calculated as described above, current location information of the overhead hoist transport (20) is acquired by adding the calculated actual movement amount of the overhead hoist transport (20) to a reference location acquired by the location indicators (B) described above.(S44)

Meanwhile, the location information calculating step (S40) according to the embodiment may further include an interval calculating step (S45) of calculating a distance between a location indicator (B) and a location indicator (B) by using the current location information of the overhead hoist transport (20), and a correction value calculating step (S46) of calculating a correction value for the movement amount of the overhead hoist transport (20) based on a difference value obtained by comparing an actual distance between the location indicator (B) and the location indicator (B) stored in advance and the measured distance between the location indicator (B) and the location indicator (B) calculated as described above.

In other words, in the embodiment, a correction value is reflected to a movement amount of the overhead hoist transport (20) calculated in the next movement amount calculating step (S43) by using the correction value acquired in the correction value calculating step (S46) through the interval calculating step (S45), and thereby the location information of the overhead hoist transport (20) can be determined more accurately by periodically correcting an error caused by various environmental factors, such as an error in an actual installation angle of the imaging unit (30).

Additionally, in the invention, if movement displacement of the feature point detected in the movement displacement detecting step (S41) is out of a preset reference range, that is, if vibration exceeding a standard value or a discontinuous/abnormal rotation angle is found, it is determined as an abnormal sign such as a crack, disconnection, or deformation of the rail (10), and an abnormal sign signal is generated and at the same time the current location information of the overhead hoist transport (20) is acquired in the same way as described above and then is transmitted to a preset target terminal. This enables an abnormal sign or an abnormal state of the rail (10) to be monitored in real time.

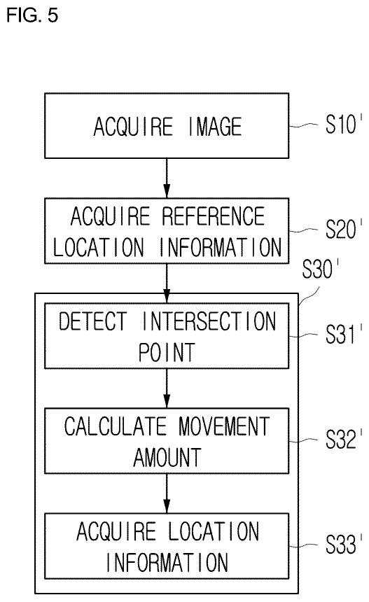

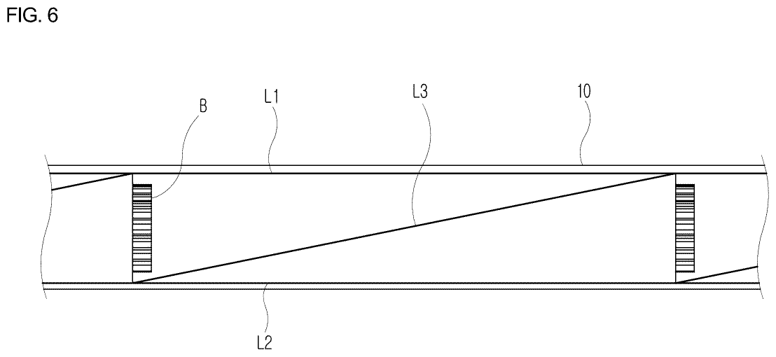

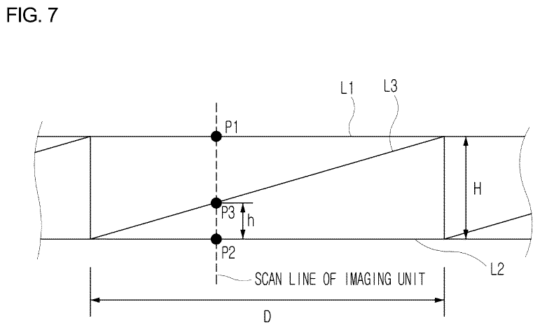

FIG. 5 is a flowchart sequentially illustrating a method for recognizing a location of an overhead hoist transport in an overhead hoist transport system according to another embodiment of the invention, FIG. 6 is a view illustrating the one side of the rail at which first and second horizontal lines and a location recognition line are provided according to the other embodiment of the invention, and FIG. 7 is a view illustrating intersection points (P1, P2, and P3) according to the embodiment of the invention.

The embodiment illustrated in FIGS. 5 to 7 enables a degree of precision to be improved and an operation speed to be increased, thereby enabling location information to be rapidly acquired.

In the embodiment, unlike the previous embodiment, a line scan camera and a barcode reader can be used together as the imaging unit (30), and as illustrated in FIG. 6, the rail (10) has a first horizontal line (L1) and a second horizontal line (L2) parallel to each other at an upper side and a lower side thereof in a length direction and has a location recognition line (L3) diagonally connecting the first horizontal line (L1) and the second horizontal line (L2).

In addition, as illustrated in FIG. 5, the method for recognizing a location of an overhead hoist transport for an overhead hoist transport system according to another embodiment of the invention includes an image acquiring step (S10′), a reference location information acquiring step (S20′), and a location information calculating step (S30′).

In the image acquiring step (S10′), the imaging unit (30) acquires an image obtained by performing line scanning on the one side of the rail (10) at a current location of the overhead hoist transport (20). At this time, as described above, the line scan camera is used as the imaging unit (30), and an image having a shape corresponding to a scan line of the imaging unit (30), that is, a vertical line-shaped image, is acquired.

In the reference location information acquiring step (S20′), if the location indicator (B) is detected by the barcode reader installed together with the line scan camera, a unique identification number is read, location information corresponding to the read identification number is acquired from location data stored in the overhead hoist transport or a server in advance, a reference location thereof is set, and the previously calculated movement amount of the overhead hoist transport (20) is initialized.

As described above, each time each location indicator (B) is detected, the movement amount of the overhead hoist transport (20) is initialized, and a movement amount of the overhead hoist transport (20) is recalculated based on location information according to the location indicator (B) stored in advance. In this manner, movement amount errors of the overhead hoist transport (20) can be prevented from being accumulated, and thereby it is possible to calculate a more accurate movement amount of the overhead hoist transport (20).

Meanwhile, in the description of the embodiment, a separate barcode reader is installed together with the line scan camera, and the location indicator is detected by the barcode reader. However, the invention is not necessarily limited to this, and the barcode reader can be omitted and the line scan camera can detect the location indicator by accumulating vertical line-shaped images acquired by the line scan camera.

Unlike the previous embodiment, the location information calculating step (S30′) of this embodiment can include an intersection point detecting step (S31′), a movement amount calculating step (S32′), and a location information acquiring step (S33′).

As illustrated in FIG. 7, the intersection point detecting step (S31′) detects intersection points (P1, P2, and P3) at which the image acquired in the image acquiring step (S10′), that is, the scan line of the imaging unit (30) intersects the first and second horizontal lines (L1 and L2) and the location recognition line (L3), respectively.

In the movement amount calculating step (S32′) of this embodiment, the current location of the overhead hoist transport (20) is recognized by detecting a location of the feature point (P3) using only the information of the intersection points (P1, P2, and P3), and this will be described in detail below.

First, actual height values (h) of P2 and P3 of the intersection points detected in the intersection detecting step are calculated. The actual height values (h) of P2 and P3 can be calculated using the following expression below.

$$h = Hy / x \qquad [ Equation 2 ]$$

(here, x represents a pixel count between P1 and P2, y represents a pixel count between P2 and P3, and H represents a distance between the first horizontal line (L1) and the second horizontal line (L2).)

At this time, a value of an x-axis distance (D) between a first point at which the location recognition line (L3) intersects the first horizontal line (L1) and a second point at which the location recognition line (L3) intersects the second horizontal line (L2), and the interval distance (H) between the first and second lines (L1) and (L2) is a fixed value from a time point at which the first and second horizontal lines (L1 and L2) and the location recognition line (L3) are provided on the rail (10), and thus those values are stored in advance.

Once the actual height values (h) of P2 and P3 are calculated as described above, the height value is substituted into [Equation 3] below to calculate an actual movement amount (M′) of the overhead hoist transport 20.

$${M}^{″} = D \times h / H \qquad [ Equation 3 ]$$

(here, D represents the x-axis distance between the first point where the location recognition line (L3) intersects the first horizontal line (L1) and the second point where the location recognition line (L3) intersects the second horizontal line (L2), H represents an interval between the first and second horizontal lines (L1 and L2).)

Finally, in the location information acquiring step (S33′), the actual movement amount (M′) of the overhead hoist transport (20) is added to the location information acquired in the reference location information acquiring step (S20′), and the current location information of the overhead hoist transport (20) is acquired.

According to the present invention described above, a process designing time can be shortened and thus costs can be reduced by installing location indicators in the same way at each semiconductor factory at the time of process design by acquiring accurate location information of the overhead hoist transport in real time and determining a work location based on the location information, there is no need to reattach location indicators and thus there is no need to work at heights due to reattachment work of the location indicators even in a case of changing work environment such as changing layout of a process or changing position of equipment so that a work time and costs thereof can be significantly reduced, and it is possible to remarkably improve post management and significantly improve efficiency of logistics transportation.

In addition, a location of an abnormal sign can be transmitted with an abnormal sign signal to a preset terminal when an abnormality such as damage, breakage, or deformation of a rail occurs during traveling of the overhead hoist transport so that an abnormal state of the rail can be detected in real time.

Although the invention has been described with relation to the above-mentioned preferred embodiments, various modifications and variations can be made without departing from the spirit and scope of the invention. Accordingly, the scope of the accompanying claims will include such modifications or variations falling within the gist of the invention.

While the present invention has been described with respect to the specific embodiments, it will be apparent to those skilled in the art that various changes and modifications may be made without departing from the spirit and scope of the invention as defined in the following claims.

What is claimed is:

1. A method for recognizing a location of an overhead hoist transport for an overhead hoist transport system that includes a rail installed on a ceiling of a work site along a preset route in advance, multiple location indicators attached at one side of the rail at preset intervals, an overhead hoist transport installed to be travelable along the rail, and an imaging unit which is installed at one side of the overhead hoist transport and acquires an image by imaging, of the rail, the one side of the rail corresponding to the overhead hoist transport and each of the location indicators, the method comprising:
an image acquiring step of acquiring a first image acquired by imaging, by the imaging unit, the one side of the rail immediately before the overhead hoist transport starts traveling and a second image acquired by imaging the one side of the rail at a current location of the traveling overhead hoist transport;
a reference location information acquiring step of acquiring, in a case where any one of the location indicators is detected on the first image, location information corresponding to the detected location indicator from location data stored in advance;
a feature point setting step of setting, as a feature point, a random pattern on the first image; and
a location information calculating step of calculating current location information of the overhead hoist transport based on the location information acquired in the reference location information acquiring step and a movement amount depending on a movement displacement of a feature point which is detected by comparing the first image with the second image.

2. The method for recognizing a location of an overhead hoist transport for an overhead hoist transport system according to claim 1,
wherein the location information calculating step includes
a movement displacement detecting step of detecting the movement displacement of the feature point by comparing the first image with the second image,
a pixel count measuring step of measuring pixel counts on an X axis and a Y axis from a location of the feature point on the first image to a location of the feature point on the second image depending on the detected movement displacement of the feature point,
a movement amount calculating step of calculating a movement amount of the overhead hoist transport based on the measured pixel counts on the X axis and the Y axis, and
a location information acquiring step of acquiring current location information of the overhead hoist transport by adding the calculated movement amount of the overhead hoist transport to the location information acquired in the reference location information acquiring step.

3. The method for recognizing a location of an overhead hoist transport for an overhead hoist transport system according to claim 2,
wherein the location information calculating step further includes
an interval calculating step of calculating a distance between the location indicator and the location indicator by using the current location information of the overhead hoist transport, and
a correction value calculating step of calculating a correction value for the movement amount of the overhead hoist transport based on a difference value obtained by comparing the distance between the location indicator and the location indicator calculated in the interval calculating step with an actual distance between the location indicator and the location indicator stored in advance, and
in a case where the movement amount calculating step is executed after the correction value is calculated, the correction value is reflected to the calculated movement amount of the overhead hoist transport.

4. A method for recognizing a location of an overhead hoist transport for an overhead hoist transport system that includes a rail which is installed on a ceiling of a work site along a preset route in advance and has a first horizontal line and a second horizontal line parallel to each other at an upper side and a lower side in a length direction and a location recognition line diagonally connecting the first horizontal line and the second horizontal line, multiple location indicators attached at one side of the rail at preset intervals, an overhead hoist transport installed to be travelable along the rail, and an imaging unit which is installed at one side of the overhead hoist transport and acquires an image by detecting each of the location indicators and performing line scanning on, of the rail, the one side of the rail corresponding to the overhead hoist transport, the method comprising:
an image acquiring step of acquiring an image acquired by performing the line scanning on the one side of the rail at a current location of the overhead hoist transport;
a reference location information acquiring step of acquiring, in a case where any one of the location indicators is detected by the imaging unit, location information corresponding to the detected location indicator from location data stored in advance; and
a location information calculating step of acquiring current location information of the overhead hoist transport based on a movement amount of the overhead hoist transport calculated by analyzing the image and the location information of the detected location indicator acquired in the reference location information acquiring step,
wherein the location information calculating step includes
an intersection point detecting step of detecting intersection points (P1, P2, and P3) at which a vertical scan line of the imaging unit intersects the first and second horizontal lines and the location recognition line, respectively, on the image,
a movement amount calculating step of calculating an actual movement amount (M″) of the overhead hoist transport by setting, as (h), either a height between the intersection point (P2) and the intersection point (P3) or a height between the intersection point (P3) and the intersection point (P1) and substituting (h) into the following [Equation], and
a location information acquiring step of acquiring current location information of the overhead hoist transport by adding the calculated actual movement amount of the overhead hoist transport to the location information of the detected location indicator acquired in the reference location information acquiring step.
$${M}^{″} = D \times h / H \qquad [ Equation ]$$
(where, D represents a distance on an X axis between a first point at which the location recognition line intersects the first horizontal line and a second point at which the location recognition line intersects the second horizontal line, and H represents an interval between the first and second horizontal lines.)

5. The method for recognizing a location of an overhead hoist transport for an overhead hoist transport system according to claim 1, further comprising
an abnormal sign sensing step of determining, as an abnormality, a case where the movement displacement of the feature point detected in the movement displacement detecting step is out of a preset reference range and transmitting the current location information of the overhead hoist transport with an abnormal sign signal to a preset target terminal.

6. The method for recognizing a location of an overhead hoist transport for an overhead hoist transport system according to claim 4, further comprising
an abnormal sign sensing step of determining, as an abnormality, a case where the movement displacement of the feature point detected in the movement displacement detecting step is out of a preset reference range and transmitting the current location information of the overhead hoist transport with an abnormal sign signal to a preset target terminal.

7. The method for recognizing a location of an overhead hoist transport for an overhead hoist transport system according to claim 1, further comprising
an initializing step of initializing the movement amount of the overhead hoist transport in a case where any one of the location indicators is detected in the reference location information acquiring step.

8. The method for recognizing a location of an overhead hoist transport for an overhead hoist transport system according to claim 4, further comprising
an initializing step of initializing the movement amount of the overhead hoist transport in a case where any one of the location indicators is detected in the reference location information acquiring step.
